(19) United States
(12) Patent Application Publication
(10) Pub. No.: US 2010/0138596 A1
(43) Pub. Date: Jun. 3, 2010

(54) INFORMATION PROCESSOR AND INFORMATION PROCESSING METHOD

(75) Inventor: Daisuke Hayashi, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/616,718

(22) Filed: Nov. 11, 2009

(30) Foreign Application Priority Data
Nov. 28, 2008 (JP) 2008-305243

(51) Int. Cl. G06F 12/08; G06F 12/02

(52) U.S. Cl. 711/104; 711/125; 711/E12.007; 711/E12.017

(57) ABSTRACT

According to one embodiment, an information processor includes a connector, a determination module, a recognition module, and a cache control module. The connector connects a storage device to the information processor. The storage device is used as a cache by an operating system which controls the information processor. The determination module determines whether to use the storage device connected to the information processor as a data readable and writable storage area. The recognition module causes the operating system to recognize the storage device as a storage area when the determination module determines to use the storage device as a storage area. The cache controller controls the operating system to use the storage device as a cache when the determination module determines not to use the storage device as a storage area.

### CROSS-REFERENCE TO RELATED APPLICATIONS

This application is based upon and claims the benefit of priority from Japanese Patent Application No. 2008-305243, filed Nov. 28, 2008, the entire contents of which are incorporated herein by reference.

### BACKGROUND

1. Field

One embodiment of the invention relates to an information processor that controls a storage device and an information processing method.

2. Description of the Related Art

Along with an improvement in computer technology, there have been proposed various hardware devices for use in computers. The use of such a hardware device increases the processing speed of a computer as well as improving user's convenience.

For example, Japanese Patent Application Publication (KOKAI) No. H10-27128 discloses a conventional technology enabling a flash memory to be used as a readable/writable disk. with the conventional technology, a flash memory can be used as a readable/writable disk, which achieves high-speed reading/writing of data.

Recently, Intel (registered trademark) turbo memory has been proposed as a hardware device to be connected to a computer to increase the processing speed of the OS. The Intel (registered trademark) turbo memory includes a non-volatile random access memory (NVRAM), which is read faster than a hard disk drive (HDD), as a cache to store data read from an HDD, thereby improving access speed.

Although having been commercialized, this turbo memory is not supported by some OSs. In this case, the turbo memory cannot be used for any purpose, let alone as a cache. Besides, if OS supports the turbo memory, the turbo memory may be required to be used for other purpose than as a cache.

According to the conventional technology described above, a flash memory is mounted on the same memory board as a dynamic random access memory (D-RAM). Thus, the flash memory is used as a disk using existing modules or the like to offer high-speed read/write performance. That is, the conventional technology is not aimed at enhancing functions, for example, to use a flash memory connected for a predetermined purpose, such as to cache data, for other purposes.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hardware configuration of a computer according to an embodiment of the invention;

FIG. 2 is an exemplary block diagram of a system including software executed by the computer in the embodiment;

FIG. 3 is an exemplary conceptual diagram for explaining the application of a turbo memory that BIOS provides to a first OS in the embodiment;

FIG. 4 is an exemplary conceptual diagram for explaining the application of the turbo memory that the BIOS provides to a second OS in the embodiment;

FIG. 5 is an exemplary flowchart of the process of recognizing the turbo memory upon activation of the computer in the embodiment;

FIG. 6 is an exemplary flowchart of the operation of a device recognition module to cause the first OS to recognize NVRAM of the turbo memory as a storage area in the embodiment; and

FIG. 7 is an exemplary flowchart of a cache control process performed by a cache processor to cause the first OS to use the turbo memory as a cache in the embodiment.

### DETAILED DESCRIPTION

Various embodiments according to the invention will be described hereinafter with reference to the accompanying drawings. In general, according to one embodiment of the invention, an information processor includes a connector, a determination module, a recognition module, and a cache controller. The connector is configured to connect a storage device to the information processor. The storage device is configured to be used as a cache by an operating system configured to control the information processor. The determination module is configured to determine whether to use the storage device connected to the information processor as a data readable and writable storage area. The recognition module is configured to cause the operating system to recognize the storage device as a storage area when the determination module determines to use the storage device as a storage area. The cache controller is configured to control the operating system to use the storage device as a cache when the determination module determines not to use the storage device as a storage area.

According to another embodiment of the invention, there is provided an information processing method applied to an information processor that executes a basic input-output system. The information processing method comprising: determining whether to use a storage device connected to the information processor as a data readable and writable storage area based on input to the information processor; causing an operating system installed on the information processor to recognize the storage device as a storage area when the storage device is determined to be used as a storage area; and controlling the operating system to use the storage device as a cache when the storage device is determined not to be used as a storage area.

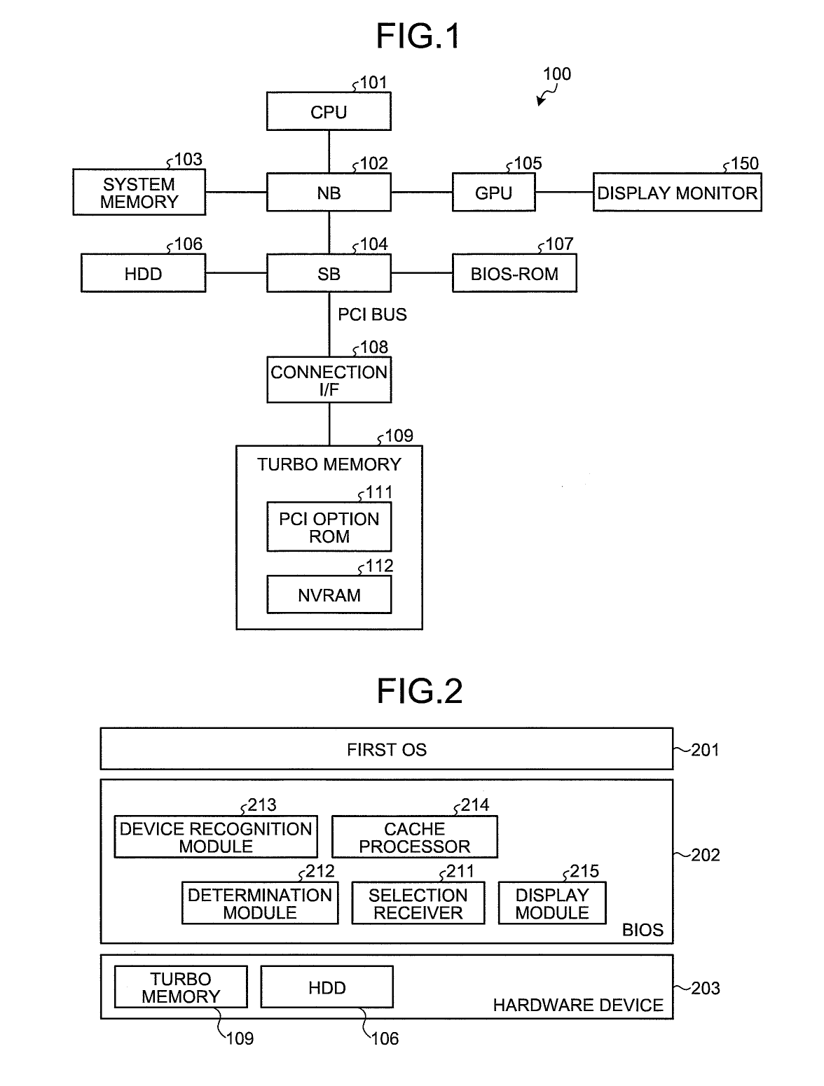

FIG. 1 is a block diagram of a hardware configuration of a computer 100 according to an embodiment of the invention. As illustrated in FIG. 1, the computer 100 comprises a CPU 101, a north bridge (NB) 102, a system memory 103, a south bridge (SB) 104, a graphics controller (GPU) 105, a hard disk drive (HDD) 106, and a BIOS-ROM 107. The computer 100 is connected to a turbo memory 109 by a peripheral component interconnect (PCI) bus via a connection interface (I/F) 108. The CPU 101 maybe integrated with the NB 102.

The CPU 101 is a processor that controls the operation of the computer 100. The CPU 101 loads an operating system (OS) from the HDD 106 into the system memory 103 and executes it. The CPU 101 also loads a system basic input-output system (BIOS) from the BIOS-ROM 107 into the system memory 103 or the like to execute it. The system BIOS is a program for hardware control.

The NB 102 connects between a local bus of the CPU 101 and the SB 104. The NB 102 comprises a built-in memory controller that controls access to the system memory 103. The NB 102 has a function of communicating with the GPU 105 through an accelerated graphics port (AGP) bus, a PCI Express serial bus, or the like.

The GPU 105 is a display controller that controls a display monitor 150 connected to the computer 100.

The SB 104 controls each device on a low pin count (LPC) bus as well as those connected to the PCI bus such as, for example, the turbo memory 109. The SB 104 comprises a built-in serial advanced technology attachment (SATA) controller for controlling the HDD 106. Examples of the connection interface I/F 108 on the PCI bus controlled by the SB 104 include a PCI connector I/F.

The turbo memory 109 comprises a PCI option ROM 111 and an NVRAM 112. The turbo memory 109 is an option card that is connectable to the computer 100. The turbo memory 109 may be, for example, Intel (registered trademark) turbo memory. If the OS installed on the computer 100 supports the Intel (registered trademark) turbo memory, upon activation of the computer 100, the NVRAM 112 of the turbo memory 109 stores read-ahead data as a cache of the HDD 106. Thus, only when the OS supports the turbo memory 109, high-speed access is possible between the OS and the HDD 106. Further, in this case, since the HDD 106 is not constantly accessed, power saving can be achieved.

The PCI option ROM ill stores data necessary to control the turbo memory 109. The system BIOS loads the data from the PCI option ROM 111 into the system memory 103. Thus, the OS executed by the CPU 101 can use the NVRAM 112 of the turbo memory 109 as a cache.

Incidentally, the turbo memory 109 is not limited to the Intel (registered trademark) turbo memory, and may be any storage device connectable to the computer 100, which can be used as a cache that temporarily stores data read by the OS or the like.

FIG. 2 is a block diagram of a system including software executed by the computer 100 of the embodiment. As illustrated in FIG. 2, the computer 100 comprises, on a hardware device 203, a first OS 201 and a BIOS 202.

The first OS 201 is an operating system executed by the CPU 101. The first OS 201 supports the turbo memory 109, and therefore, when the turbo memory 109 is connected to the computer 100, it can use the turbo memory 109 as a cache. The first OS 201 may be, for example, Windows (registered trademark) Vista.

The BIOS 202 is stored in the BIOS-ROM 107. The BIOS 202 is loaded by the CPU 101 into the system memory 103 or the like, and is executed. To change how to use the turbo memory 109 connected to the computer 100, the BIOS 202 comprises a selection receiver 211, a determination module 212, a device recognition module 213, a cache processor 214, and a display module 215.

The display module 215 displays a setting screen for the BIOS 202. Through the setting screen, a user can specify various settings for the BIOS 202. As an example of the parameter of the BIOS 202 that the user can set, the user is allowed to specify whether to use the turbo memory 109 as a storage area.

When the display module 215 displays the setting screen for the BIOS 202, the selection receiver 211 receives various settings for the BIOS 202 input through an input device. Examples of the settings for the BIOS 202 include a selection as to whether to use the turbo memory 109 as a storage area.

The determination module 212 determines whether to use the turbo memory 109 as a readable/writable storage area according to the settings specified by the user. In the embodiment, the determination module 212 determines whether to use the turbo memory 109 as a storage area according to a selection received by the selection receiver 211.

When the determination module 212 determines to use the turbo memory 109 as a storage area, the device recognition module 213 causes the first OS 201 to recognize the NVRAM 112 of the turbo memory 109 as a storage area.

In the embodiment, if the device recognition module 213 causes the first OS 201 to recognize the NVRAM 112 of the turbo memory 109 as a storage area, a device driver for a storage device is embedded in the NVRAM 112. Thus, the NVRAM 112 of the turbo memory 109 can be used as a storage area of a general storage device as with solid state drive (SSD), HDD, and the like.

Having determined that the device recognition module 213 does not cause the first OS 201 to recognize the NVRAM 112 of the turbo memory 109 as a storage area, the cache processor 214 controls the first OS 201 to use the turbo memory 109 as a cache. In the embodiment, the PCI option ROM 111 is loaded before Int19h, which is used as a standard boot method, is invoked to change a device to boot up. Thus, the turbo memory 109 can be used as a cache.

More specifically, in the case where the PCI option ROM 111 is loaded before Int19h is invoked, when the HDD 106 that stores the first OS 201 is specified to boot up, the cache processor 214 reads ahead data from the HDD 106. The cache processor 214 then stores the read-ahead data in the NVRAM 112 of the turbo memory 109, and sets the turbo memory 109 as an access destination which is accessed before the HDD 106. With this, the first OS 201 can be caused to use the turbo memory 109 as a cache.

With this configuration, the BIOS 202 of the embodiment can provide the first OS 201 with the turbo memory 109 as a cache as well as the NVRAM 112 of the turbo memory 109 as a readable/writable storage area.

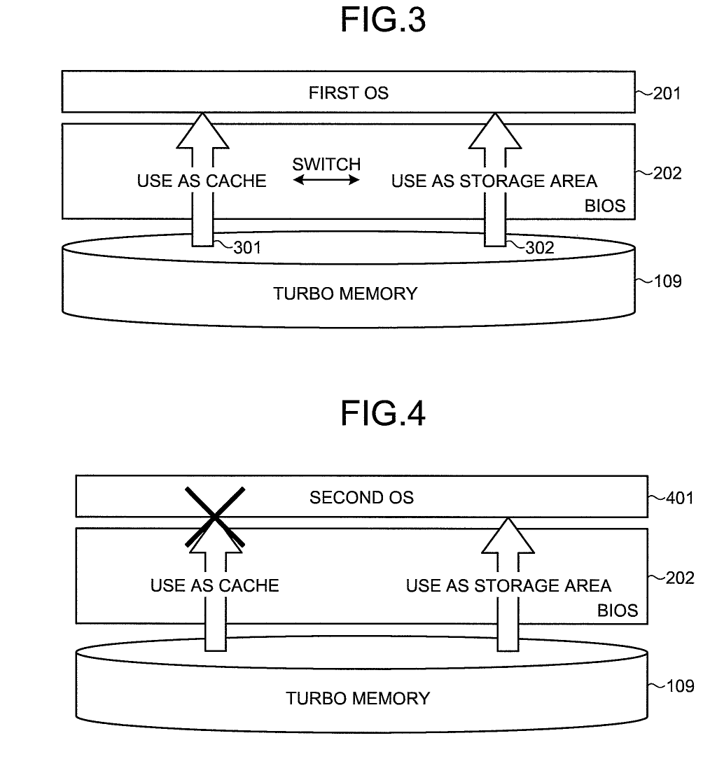

FIG. 3 is a conceptual diagram for explaining the application of the turbo memory 109 that the BIOS 202 provides to the first OS 201. As illustrated in FIG. 3, the BIOS 202 can selectively provide the turbo memory 109 to the first OS 201 as a cache (indicated by arrow 301) or provide it to the first OS 201 as a readable/writable storage area (indicated by arrow 302). That is, the BIOS 202 switches the application of the turbo memory 109 between a cache and a storage area. The BIOS 202 can provide the turbo memory 109 to the first OS 201 as a cache because the first OS 201 supports the turbo memory 109. In the following, a description will be given of the case of an OS that does not support the turbo memory 109.

FIG. 4 is a conceptual diagram for explaining the application of the turbo memory 109 that the BIOS 202 provides to a second OS 401. As illustrated in FIG. 4, the BIOS 202 can provide the turbo memory 109 to the second OS 401 as either a cache or a storage area. When provided with the turbo memory 109 as a cache, the second OS 401 cannot use the turbo memory 109. Meanwhile, when provided with the turbo memory 109 as a storage area, the second OS 401 can use the turbo memory 109 effectively.

That is, in general computers, the second OS 401 cannot use the turbo memory 109 connected thereto as a cache, and further recognizes the turbo memory 109 as an unidentified device. As a result, the turbo memory 109 cannot be used for any purpose.

On the other hand, in the computer 100 comprising the BIOS 202 of the embodiment, the BIOS 202 can cause the second OS 401 to recognize the turbo memory 109 as a storage area. Thus, even the second OS 401, which does not support the function of the turbo memory 109, can use the NVRAM 112 of the turbo memory 109 as a storage area. In other words, with the BIOS 202 of the embodiment, regardless of whether an OS supports the function of the turbo memory 109, the OS can use the turbo memory 109 as a storage area. Examples of the OS that does not support the function of the turbo memory 109 include Windows (registered trademark) XP and Linux (registered trademark).

Incidentally, in the embodiment, when the BIOS 202 is set up, the computer 100 to which connected the turbo memory 109 receives a selection from the user as to whether to use the turbo memory 109 as a storage area such as SSD.

Upon receipt of a selection to use the turbo memory 109 as a storage area, a booted OS can use the turbo memory 109 as a storage area of a storage device (drive), regardless of the type of the OS, under the control of the BIOS 202.

On the other hand, upon receipt of a selection not to use the turbo memory 109 as a storage area, only an OS that supports the function of the turbo memory 109 (such as the first OS 201) can use the turbo memory 109 as a cache. An OS that does not support the function of the turbo memory 109 (such as the second OS 401) recognizes the turbo memory 109 as an unidentified device, and therefore cannot use the turbo memory 109.

As described above, according to the embodiment, the computer 100 comprises the BIOS 202 that allows the turbo memory 109 to be used as a storage area regardless of the type of the OS installed thereon. Especially, in the case of an OS that does not support the function of the turbo memory 109, differently from the conventional technology in which the turbo memory 109 is regarded as an unidentified device, the NVRAM 112 of the turbo memory 109 can be used as a storage area. This is particularly effective.

In the other words, according to the embodiment, a series of processes that the BIOS 202 performs to support the turbo memory 109 is replaced by the process to access an existing device (a storage device). Thus, the turbo memory 109 can be used as a nonvolatile (NV) storage device such as SSD to which the turbo memory 109 is connected via miniPCI.

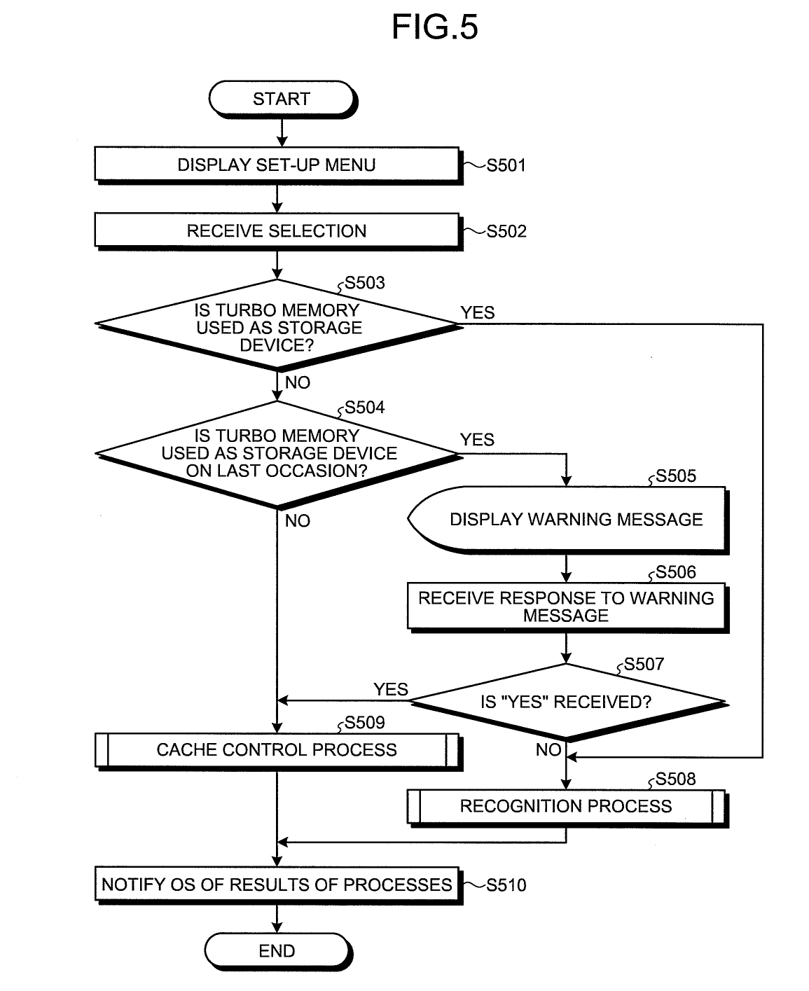

A description will now be given of the process of recognizing the turbo memory 109 upon activation of the computer 100 illustrated in FIG. 1. FIG. 5 is a flowchart of the process of recognizing the turbo memory 109 upon activation of the computer 100.

First, while the BIOS 202 of the computer 100 is being set up, the display module 215 displays a set-up menu (S501). It is herein assumed that the set-up menu contains a menu item to select whether to use the turbo memory 109 as a storage device. Incidentally, the set-up menu need not be necessarily displayed each time the computer 100 is activated. For example, the set-up menu may be displayed upon receipt of predetermined input from the user.

Thereafter, the selection receiver 211 receives a selection as to whether to use the turbo memory 109 as a storage device through the menu item on the set-up menu (S502).

Depending on the selection received by the selection receiver 211, the determination module 212 determines whether to use the turbo memory 109 as a storage device (S503). When the determination module 212 determines to use the turbo memory 109 as a storage device (Yes at 5503), recognition process is performed to recognize the turbo memory 109 as a storage device (S508).

On the other hand, having determined not to use the turbo memory 109 as a storage device (No at S503), the determination module 212 determines whether the turbo memory 109 is used as a storage device on the last occasion (S504). This determination as to whether the turbo memory 109 is used as a storage device on the last occasion may be made by referring to data stored in the NVRAM 112 of the turbo memory 109. This determination may also be made by storing previous settings in advance and referring to the settings. This determination may be made in any other manners such as, for example, to inquire of the user whether the turbo memory 109 is used as a storage device on the last occasion.

When the determination module 212 determines that the turbo memory 109 is not used as a storage device on the last occasion (No at S504), cache control process is performed to use the turbo memory 109 as a cache (S509).

On the other hand, when the determination module 212 determines that the turbo memory 109 is used as a storage device on the last occasion (Yes at S504), the display module 215 displays on the display screen a warning message such as “data stored in the turbo memory is ready to be deleted. Is it OK to delete the data?” (S505). After that, the selection receiver 211 receives a response to the warning message, “Yes” or “No” (S506).

According to the response, “Yes” or “No”, received by the selection receiver 211 at S506, the determination module 212 determines whether to use the turbo memory 109 as a storage device (S507).

When the selection receiver 211 receives “Yes” as the response to the warning message (Yes at S507), the determination module 212 determines that the data stored in the turbo memory 109 can be deleted to use it as a cache. Thus, the cache control process is performed to use the turbo memory 109 as a cache (S509).

On the other hand, when the selection receiver 211 receives “No” as the response to the warning message (No at S507), the determination module 212 prevents the data from being deleted from the turbo memory 109 (i.e., the determination module 212 determines that the turbo memory 109 is not to be used as a cache). Thus, the recognition process is performed to recognize the turbo memory 109 as a storage device so that the data stored in the turbo memory 109 is available and also the turbo memory 109 can be used as a storage device (S508).

In other words, at S508, the device recognition module 213 causes the first OS 201 to recognize the NVRAM 112 of the turbo memory 109 as a storage area. This recognition process will be described in detail later.

Besides, at S509, the cache processor 214 controls the first OS 201 to use the turbo memory 109 as a cache. This cache control process will be described in detail later.

After that, the BIOS 202 notifies the first OS 201 of the results of the processes at S508 and S509 (S510). Thus, the first OS 201 effectively uses the turbo memory 109 as a cache or a storage device.

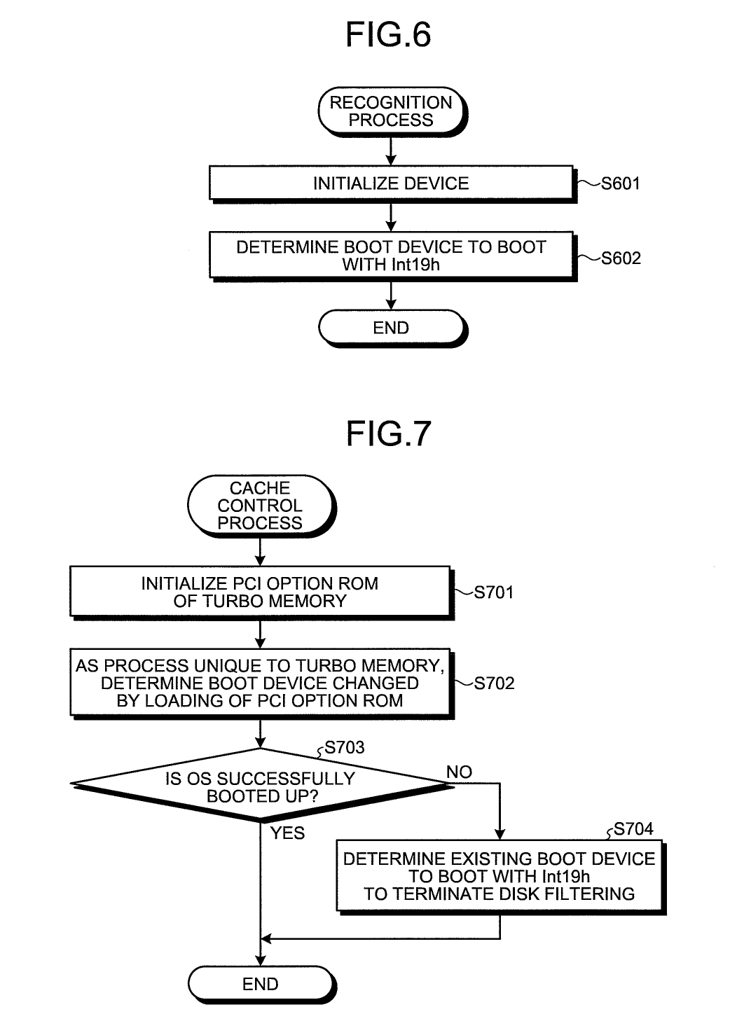

A description will be given of the recognition process performed by the device recognition module 213 at S508 in FIG. 5 to cause the first OS 201 to recognize the NVRAM 112 of the turbo memory 109 as a storage area. FIG. 6 is a flowchart of the operation of the device recognition module 213 to cause the first OS 201 to recognize the NVRAM 112 of the turbo memory 109 as a storage area.

First, the device recognition module 213 performs an initialization process so that the turbo memory 109 can be recognized as a storage device (S601). With this initialization process, the device recognition module 213 can cause the first OS 201 to recognize the turbo memory 109 as a storage device. The initialization process to recognize the turbo memory 109 as a storage device may be performed in the same manner as the case of conventional SSD or the like, and further description is not considered necessary.

The device recognition module 213 then determines a boot device to boot with Int19h (S602). In the embodiment, the device recognition module 213 determines the HDD 106 as the boot device, and thereby the first OS 201 stored in the HDD 106 is booted up.

A description will then be given of the cache control process performed by the cache processor 214 at 5509 in FIG. 5 to cause the first OS 201 to use the turbo memory 109 as a cache. FIG. 7 is a flowchart of the cache control process performed by the cache processor 214 to cause the first OS 201 to use the turbo memory 109 as a cache.

First, the cache processor 214 initializes the PCI option ROM 111 of the turbo memory 109 (S701). To initializes the PCI option ROM 111, the cache processor 214 secures an area for the PCI option ROM 111 in the system memory 103, and initializes the secured memory area.

The cache processor 214 then, as a process unique to the turbo memory 109, determines a boot device changed by the loading of the PCI option ROM 111 (S702). The cache processor 214 determines the HDD 106 as the boot device, and thereby the first OS 201 stored in the HDD 106 is booted up. When the HDD 106 is determined as a read destination, data in the HDD 106 is stored in advance in the turbo memory 109, and the turbo memory 109 is controlled to be accessed first. The NVRAM 112 is read faster than the HDD 106, and therefore, the read speed can be increased.

Thereafter, the cache processor 214 determines whether the OS (the first OS 201) can successfully boot up by the determined boot device (S703). If the OS (the first OS 201) can successfully boot up (Yes at S703), the process ends.

On the other hand, when determining the OS (the first OS 201) cannot successfully boot up (No at S703), the cache processor 214 determines an existing boot device to boot with Int19h, thereby terminating the cache control process to use the turbo memory 109 as a cache (S704). In this manner, if the OS does not support the function of the turbo memory 109 and fails to boot up at S703, the OS is booted up in an ordinary manner.

As described above, according to the embodiment, when the determination module 212 determines to use the turbo memory 109 as a cache, the OS can use the turbo memory 109 as a cache. Thus, it is possible to achieve high-speed access. Moreover, even in the case where the OS does not have the function of using the turbo memory 109 as a cache, differently from the conventional technology in which the OS generally regards the turbo memory 109 as an unidentified device, the turbo memory 109 can be used as a storage area of a storage device.

In this manner, according to the embodiment, the application of the turbo memory 109 connected via a miniPCI can be enhanced. This allows the user to select how to use the turbo memory 109. Incidentally, when the turbo memory 109 is selected to be used as a storage device, the BIOS 202 may determine the turbo memory 109 as a boot device.

In other words, in the computer 100 to which is connected the turbo memory 109, with the operation of the BIOS 202 described above, even if the OS installed thereon does not support the function of the turbo memory 109, the NVRAM 112 of the turbo memory 109 can be used as a high-speed storage drive. Accordingly, the turbo memory 109 can be used effectively. This adds a new value to the turbo memory 109, and thus the turbo memory 109 is expected to be widespread as a further useful device.

Note that the turbo memory 109 is used as a storage area of a storage device only by the switching operation of the BIOS 202. Therefore, the existing operation is neither interrupted nor disturbed.

If the turbo memory 109 becomes readable/writable as a storage area of a storage device, it can be used for various purposes such as to install and swap OS as well as storing a temporary file. Furthermore, the use of the NVRAM 112 enables read/write operation to be faster compared with the HDD 106.

A modification of the embodiment will be described. While the above embodiment describes an example in which the application of the turbo memory 109 is switched according to a selection received from the user. However, the application of the turbo memory 109 need not necessarily be switched based on user' s selection. According to the modification, the determination module 212 may determine whether the OS installed on the computer 100 supports the cache function of the turbo memory 109 to determine how to use the turbo memory 109 based on the determination result. If, for example, the determination module 212 determines that the OS does not support the cache function, the device recognition module 213 causes the OS to recognize the turbo memory 109 as a storage device. On the other hand, if the determination module 212 determines that the OS supports the cache function, the cache processor 214 controls the OS to use the turbo memory 109 as a cache. This is by way of example only and not to be construed as limiting. The application of the turbo memory 109 may be switched in any other manner according to various purposes.

The BIOS 202 executed on the computer 100 of the embodiment may be provided as being stored in advance in ROM or the like.

The BIOS 202 executed on the computer 100 of the embodiment may also be provided as being stored in a computer-readable storage medium, such as a compact disk read-only memory (CD-ROM), a flexible disk (FD), a compact disc-recordable (CD-R), or a digital versatile disc (DVD), in an installable or executable format.

The BIOS 202 executed on the computer 100 of the embodiment may also be stored in a computer connected via a network such as the Internet so that it can be downloaded therefrom. The BIOS 202 may also be provided or distributed via a network such as the Internet.

The BIOS 202 executed on the computer 100 of the embodiment includes modules that implement the modules described above (such as the selection receiver 211, the determination module 212, the device recognition module 213, the cache processor 214, and the display module 215), respectively. As hardware, CPU (a processor) loads the BIOS 202 from the ROM into a main memory and executes it. Thus, the selection receiver 211, the determination module 212, the device recognition module 213, the cache processor 214, and the display module 215 are implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a connector configured to connect a storage device to the information processor, the storage device configured to be used as a cache by an operating system configured to control the information processor;
a determination module configured to determine whether to use the storage device connected to the information processor as a data readable and writable storage area;
a recognition module configured to cause the operating system to recognize the storage device as a storage area when the determination module determines to use the storage device as a storage area; and
a cache controller configured to control the operating system to use the storage device as a cache when the determination module determines not to use the storage device as a storage area.

2. The information processor of claim 1, wherein the cache control module is configured to set the operating system to access the storage device prior to accessing a predetermined storage module when the operating system accesses the predetermined storage module to read data to control the operating system to use the storage device as a cache.

3. The information processor of claim 1, wherein the storage device is a non-volatile random access memory.

4. The information processor of claim 1, further comprising a basic input-output system, wherein
the basic input-output system comprises the determination module, the recognition module, and the cache controller.

5. The information processor of claim 1, further comprising a selection receiver configured to receive a selection as to whether to use the storage device as a storage area through an input device, wherein
the determination module is configured to determine whether to use the storage device as a storage area based on the selection received by the selection receiver.

6. The information processor of claim 1, wherein the determination module is configured to determine whether to use the storage device as a storage area based on the operating system installed on the information processor.

7. An information processing method applied to an information processor that executes a basic input-output system, the information processing method comprising:
determining whether to use a storage device connected to the information processor as a data readable and writable storage area based on input to the information processor;
causing an operating system installed on the information processor to recognize the storage device as a storage area when the storage device is determined to be used as a storage area; and
controlling the operating system to use the storage device as a cache when the storage device is determined not to be used as a storage area.
